(19) United States
(12) Patent Application Publication
(10) Pub. No.: US 2013/0341277 A1
(43) Pub. Date: Dec. 26, 2013

(54) Porous Film

(71) Applicant: MASSACHUSETTS INSTITUTE OF TECHNOLOGY, Cambridge, MA (US)

(72) Inventors: Jason R. Kovacs, Cambridge, MA (US); Paula T. Hammond, Newton, MA (US)

(21) Appl. No.: 13/926,507

(22) Filed: Jun. 25, 2013

Related U.S. Application Data
(60) Provisional application No. 61/664,123, filed on Jun. 25, 2012.

(51) Int. Cl. C02F 1/44

(52) U.S. Cl. CPC C02F 1/441
USPC 210/654; 210/500.36; 427/244

(57) ABSTRACT

A reverse osmosis (RO) membrane can include a porous substrate, a multilayer film arranged on the substrate, which includes a first layer including a polyelectrolyte and a second layer including a plurality of clay particles, where the first layer is arranged adjacent to the second layer. The multilayer film can be prepared by a spray-LbL process. The resulting RO membrane can provide high water permeability combined with high salt rejection.

### CLAIM OF PRIORITY

This application claims the benefit of prior U.S. Provisional Application No. 61/664,123, filed on Jun. 25, 2012, which is incorporated by reference in its entirety.

### TECHNICAL FIELD

This invention relates to porous films, methods of making the porous films, and methods of using the porous films, particularly in reverse osmosis applications.

### BACKGROUND

Although the vast majority of the Earth's surface is dominated by oceans, seas, lakes, and glaciers, geological surveys indicate a mere 0.8% of this supply is freshwater that is adequate for human consumption (Gleick, “World's Water”, 2006). Additionally, industrial production of food and chemicals, mining operations, and other human activities can produce significant amounts of wastewater that must be treated before it can be reused or discharged to the environment. Thus, efficient water desalination is vital to sustaining the quality of life of human populations living without sufficient access to freshwater resources.

One method of desalination, reverse osmosis (RO), involves forcing salty water through a membrane under pressure. The membrane is chosen so that water passes more easily than salt ions; as a result, the water collected on the opposite side of the membrane is less salty than the starting supply of water. RO can be very effective at providing fresh water, but can be an energy intensive process, especially when large quantities of fresh water are required. Thus there is a need for RO membranes with increased efficiency, i.e., water permeability and salt rejection.

### SUMMARY

Highly selective membranes for use in continuous reverse osmosis (RO) processes can reduce both the capital and operating costs for modern desalination operations. The flexibility of the spray layer-by-layer (spray-LbL) assembly process enables the deposition of composite thin films on porous hydrophilic substrates to serve as a selective layer, and is particularly suited because large asymmetric films can be deposited orders of magnitude faster than with traditional dip-LbL. The composition and physical properties of spray-LbL assembled composite films can be fine-tuned by manipulating the film assembly conditions.

In one aspect, a reverse osmosis membrane can include a porous substrate, a multilayer film arranged on the substrate, and a second layer including a plurality of clay particles. The multilayer film can include a first layer including a polyelectrolyte. The first layer can be arranged adjacent to the second layer.

In certain circumstances, the multilayer film can include a plurality of bilayers, each bilayer including a first layer including a polyelectrolyte and a second layer including a plurality of clay particles arranged adjacent to the first layer.

In certain circumstances, the multilayer film can include a series of alternating layers, the series alternating between a first layer including a polyelectrolyte and a second layer including a plurality of clay particles arranged adjacent to the second layer. The clay particles can be negatively charged when in a neutral aqueous solution. The clay particles can be plate-shaped. In some examples, the clay particles can include a laponite clay. The polyelectrolyte can be positively charged when in a neutral aqueous solution. For example, the polyelectrolyte can include PDAC.

In certain circumstances, the porous substrate can be a nanoporous membrane.

In certain circumstances, the multilayer film can include from 5 to 250 bilayers. The multilayer film can have a total film thickness in the range of 15 nm to 750 nm. The thickness can be less than 1.3 microns.

In another aspect, a method of making a reverse osmosis membrane can include building a multilayer film on a substrate, wherein the multilayer film includes a first layer including a polyelectrolyte and a second layer including a plurality of clay particles. The first layer can be arranged adjacent to the second layer.

In certain circumstances, building the multilayer film can include depositing the first layer including a polyelectrolyte, depositing the second layer including a plurality of clay particles over the first layer, thereby forming a bilayer and repeating the two depositing steps a predetermined number of times. Depositing the first layer can include spraying a solution of the polyelectrolyte. Depositing the second layer can include spraying a solution of the clay particles. The depositing steps can be repeated from 5 to 250 bilayers, thereby forming from 5 to 250 bilayers.

In another aspect, a method of desalinating water can include contacting an aqueous salt solution with one face of a reverse osmosis membrane including a porous substrate and a multilayer film arranged on the substrate and applying pressure to the aqueous salt solution. The multilayer film can include a first layer including a polyelectrolyte and a second layer including a plurality of clay particles. The first layer can be arranged adjacent to the second layer.

Other aspects, embodiments, and features will be apparent from the following description, the drawings, and the claims.

### BRIEF DESCRIPTION OF THE DRAWINGS

FIG. 1 is a schematic depiction of a reverse osmosis membrane.

FIG. 2 is a graph showing the relationship of film thickness and number of bilayers in a multilayer film.

FIG. 3 shows cross sectional (upper) and surface (lower left) SEM images of multilayer films, and the relation between assembly conditions and bilayer thicknesses (lower right).

FIG. 4 are images illustrating surface topography and roughness of multilayer films.

FIGS. 5A and 5B show the relationship between spray times and the composition of multilayer films.

FIG. 6 shows the average salt rejection and water permeability of different RO membranes.

### DETAILED DESCRIPTION

Layer-by-layer (LbL) assembly is a process through which thin films are assembled via the sequential deposition of film components with complementary functionality, typically opposite electrostatic charge (Decher, Macromolecules, 1993). This assembly technique has been used to incorporate diverse materials such as nanotubes (Kotov, Nat. Mat., 2002), nanoparticles and nanowires (Kotov, Acct. Chem. Res., 2008), nanoplates (Mallouk, JACS, 1994), dyes (Crane, Langmuir, 1995), organic nanocrystals (Kotov, Biomacro., 2005), drugs (Hammond, Langmuir, 2005), DNA (61/Decher, Macro., 1993), and viruses (62/Belcher-Hammond, Nat. Mat., 2006) into multilayer thin films. Films containing these materials can be utilized for a wide range of applications, from methanol fuel cell membranes (Kang, Elect. Acta, 2004), solar cells (Kumar, Langmuir, 2003), drug release (Hammond, Langmuir, 2005), defense against chemical agents (Krogman, Langmuir, 2007), and water purification membranes (Tieke, Langmuir, 2003; Tieke, App. Surf. Sci., 2004; Pavasant, Eur. Poly. J., 2008; and Decher, Eur. Phys. J.E., 2001).

In conventional LbL assembly, a substrate to be coated with a thin film is repeatedly dipped in solutions of the complementary materials. Each dipping cycle deposits a coating of one material over the underlying layers. In a variation of this method, film components can be aerosolized and convectively transported to the film interface through a technique called spray layer-by-layer (spray-LbL) assembly. Assembly of multilayer films via the spray-LbL technique is particularly suited for the creation of selective layers because asymmetric films can be deposited one to two orders of magnitude more quickly and over a greater surface area than is possible or convenient with traditional dip-LbL assembly (Krogman, Nat. Mat., 2009). The composition of the deposited films can be controlled via manipulation of the process conditions such as spray times, concentration of the solutions, and ionic strength.

Prior works have examined the use of diverse approaches such as pure polyelectrolyte films (Tieke, Langmuir, 2003) and metal-ion complexed polymers (Tieke, Jour. Mem. Sci., 2008). Clay-containing composites have been used with some success in water microfiltration applications (Adhikari-Ghosh, Jour. App. Poly. Sci., 2003; Abbasi et al., Desal. & Water Treat.; 2012), but clay particles have not previously been incorporated into a LbL-assembled film to serve as a selective layer in an RO membrane.

In an RO membrane, alternating sheet-like layers of clay intercalated with layers of polyelectrolyte can provide a high degree of path length tortuosity for solvated ions without inhibiting smaller water molecules to the same extent. A similar effect is observed in models for composite polymer-clay membranes used in gas permeation applications (Choudalakis, Eur. Poly. Jour., 2008). Thus, LbL-assembled composite polyelectrolyte-clay films can be an effective and efficient selective layer in an RO membrane.

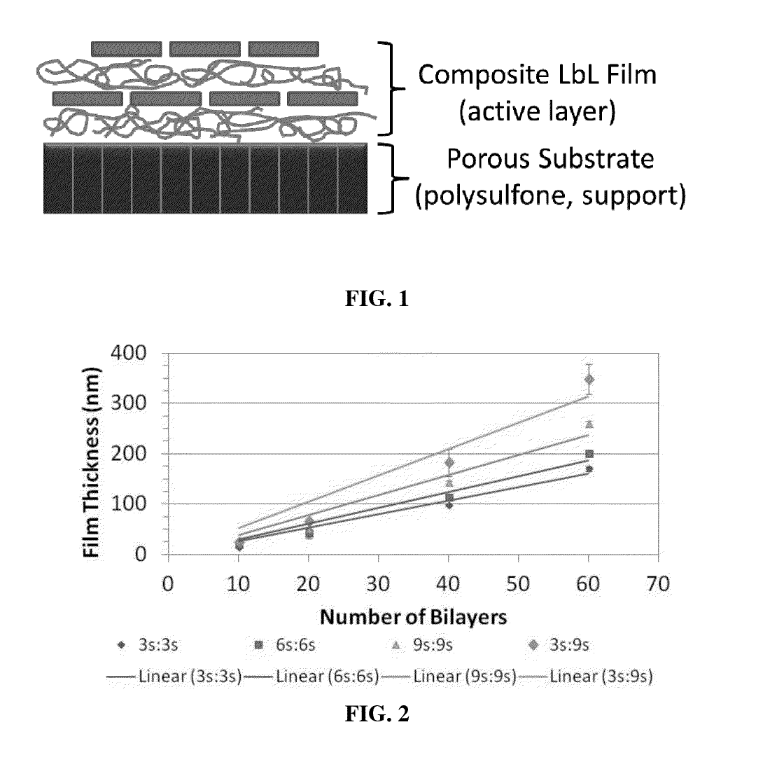

The flexibility of the LbL assembly process allows the preparation of composite polyelectrolyte/clay multilayer films on porous substrates to provide RO membranes. FIG. 1 shows a schematic diagram of an LbL RO membrane, in which a porous substrate supports a multilayer film, in other words, the multilayer film is arranged on the substrate. In FIG. 1, the porous substrate is labeled as a polysulfone support; this is but one non-limiting example of a suitable substrate. The multilayer film can include at least one layer including a polyelectrolyte; and at least one layer including a plurality of clay particles. In general, the layer including a polyelectrolyte will be adjacent to the layer including a plurality of clay particles. The two layers can be associated with one another by virtue of electrostatic attraction. This arrangement, of a layer including a polyelectrolyte adjacent to a layer including a plurality of clay particles, can be referred to as a bilayer. The multilayer film can include a plurality of such bilayers. In some cases, each bilayer can be adjacent to another such bilayer. In this case, the multilayer film includes a series of alternating layers, the series alternating between a layer including a polyelectrolyte and a layer including a plurality of clay particles. Such a structure can be formed by alternately depositing layers including polyelectrolytes and layers including a plurality of clay particles (e.g., using an LbL process).

A polyelectrolyte has a backbone with a plurality of charged functional groups attached to the backbone. A polyelectrolyte can be polycationic or polyanionic. A polycation has a backbone with a plurality of positively charged functional groups attached to the backbone, for example poly(allylamine hydrochloride). A polyanion has a backbone with a plurality of negatively charged functional groups attached to the backbone, such as sulfonated polystyrene (SPS) or poly(acrylic acid), or a salt thereof. Some polyelectrolytes can lose their charge (i.e., become electrically neutral) depending on conditions such as pH. Some polyelectrolytes, such as copolymers, can include both polycationic segments and polyanionic segments.

The number of bilayers can be in the range of 1 to 500, 5 to 250, 10 to 100, or 20 to 80. The total thickness of the multilayer film can be in the range of from 50 nm or less to 500 nm or greater. In some cases, the total thickness of the multilayer film can be in the range of 50 nm to 400 nm, 75 nm to 300 nm, or 100 nm to 200 nm.

### EXAMPLES

In this work, the structure, flux, and ion rejection properties of composite films constructed with a strong positively-charged polyelectrolyte, poly(diallyldimethylammonium chloride) (abbreviated PDAC), and a cation-exchanged laponite clay (abbreviated LAP) were characterized for use as a novel RO selective layer. Furthermore, permeability and selectivity of this material system were calculated as a function of film composition.

### Materials and Methods

### Laponite Clay Dispersion

Laponite clay was provided by Southern Clay Products. Clay dispersions were prepared at a concentration of 1.0% by wt. laponite clay and the balance reagent-grade water with one-half hour mixing on a magnetic stir plate followed by 8 hours of ultrasonication.

### Substrate Preparation

Commercially-available Millipore nanofiltration membranes with 220 nm pores were purchased and used as support layers for film deposition. NF membranes were plasma-cleaned in a Harrick Plasma Cleaner/Sterilizer PDC-32G at 18 W for 30 seconds to clean the surface as well as deposit oxide groups to create a negative surface charge for film deposition. Substrates were then soaked in a 10 mM PDAC solution before spray-LbL process to deposit a layer of PDAC.

### Spray Layer-by-Layer (Spray-LbL)

Films are constructed using a custom-built spraying apparatus. 10 mM PDAC solution was adjusted to pH 10.0 using a Φ340 pH/Temp Meter, and then aerosolized with N₂ or Ar gas at 20 psi and are sprayed onto the substrate, which is mounted to a motor that rotates at 10 rpm. The standard deposition program for one (PDAC/LAP) bilayer involves spraying the PDAC solution for 3 seconds, a 5 second drain period, a 10 second rinse with pH-adjusted water, followed by a 5 second rinse drain period. The sequence is repeated for the clay dispersion. Films assembled at different film component spray times are identified by the expression ns:ms, where n refers to the spray time of PDAC, and m refers to the spray time of LAP.

### Profilometry

A Dektak 150 profilometer was used to determine the film thickness. Profilometry samples were deposited on glass slides plasma-cleaned for 5 minutes, otherwise the standard substrate preparation protocol above was used.

### Film Imaging

Both a JEOL JSM-6060 Scanning Electron Microscope (SEM) and a Vecco Dimension 3100 Atomic Force Microscope (AFM) were used to image both film surfaces and cross-sections. Cross-sectional SEM samples were prepared via the cryo-fracture method by submerging the sample in liquid N₂ and then physically separated.

### Composition Analysis

A TA Instruments Q50 Thermogravimetric Analyzer (TGA) was used to determine the film composition of free-standing films assembled on polystyrene chips. A simple operating program was used: temperature equilibration at 50° C. for 5 minutes, followed by a ramp up to 800° C. at the rate of 10° C./min, followed by a final temperature equilibration at 800° C. for 5 minutes.

### Dead-End Permeation Cell

A Sterlitech HP4750 dead-end permeation cell was used to determine both water and salt permeability. The cell was operated between 50 and 250 psi for films assembled on nanofiltration membranes. The conductivity of the collected permeate was measured with an Omega CDH152 conductivity meter.

### Results and Discussion

### Film Characterization

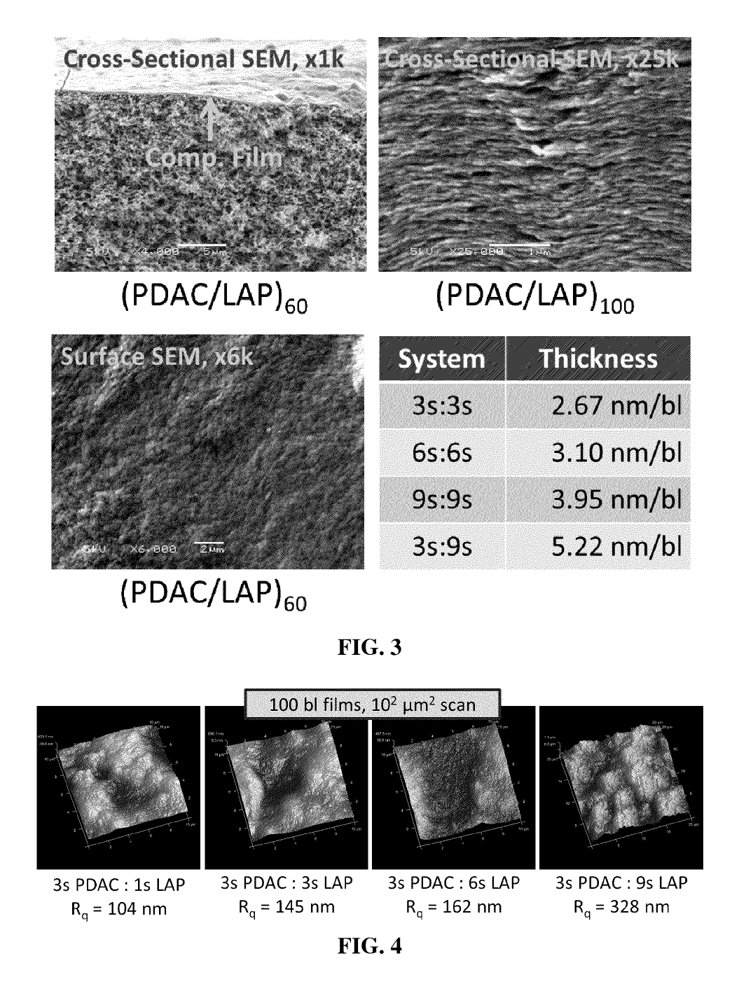

The (PDAC/LAP)ₙ films assembled exhibited linear growth over an array of spray times from 3 seconds per film component to 9 seconds per film component (FIG. 2). The increase in spray time parameters corresponded to an increase in film thickness per bilayer, indicating greater incorporation of both film components. Sub-monolayer growth was observed for films assembled under 10 deposition cycles; SEMs of (PDAC/LAP)₆₀ and (PDAC/LAP)₁₀₀ films assembled on nanofiltration membranes are shown in FIG. 3.

The surface roughness of the composite film was found to be a strong function of the number of bilayers sprayed and a weaker function of the spray times for the film assembly (FIG. 4). Surface roughness measured through 10×10 μm² AFM samples were found to increase super-linearly as a function of the number of bilayers deposited.

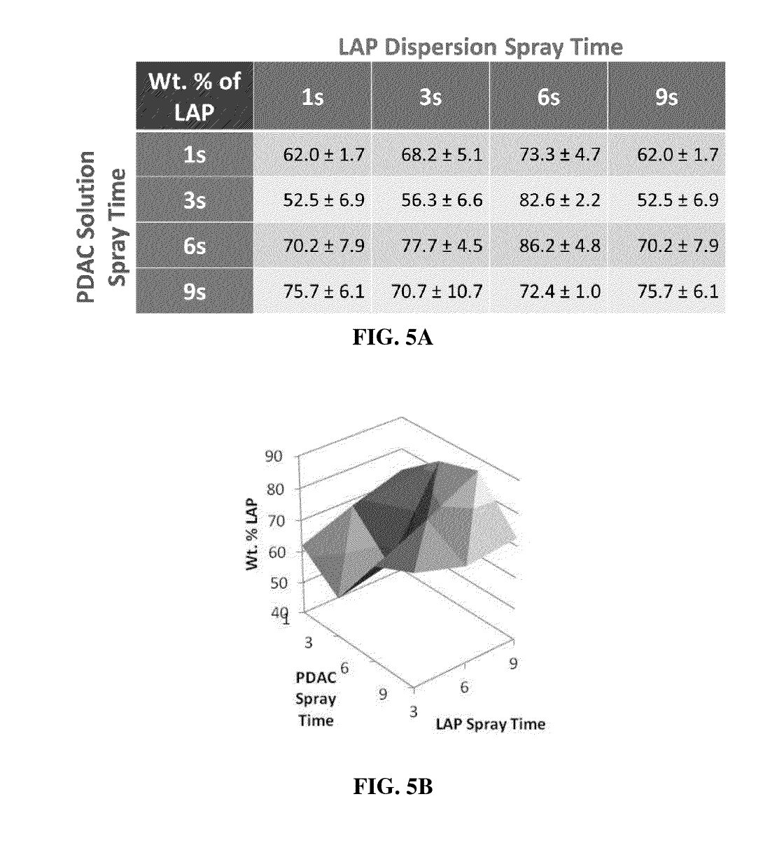

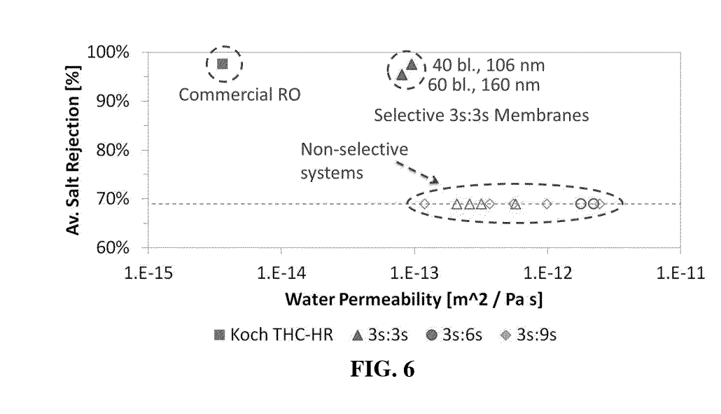

The manipulation of the spray time parameters has a direct effect on the composition of the film. As shown in FIGS. 5A-5B, the film composition was shown to vary between a minimum of 52% by weight clay and a maximum of roughly 86% by weight clay, with the balance PDAC. The prime determinant in the film composition appeared to be the spray time of LAP; there also appeared to be little difference between the 1 s and 3 s PDAC spray films when assembled with 3 s or 6 s LAP. An increase in the spray time of one film component did not necessarily lead to an increase in the weight percent of that component in the final film because the incorporation of both film components must be taken into account; the incorporation of the clay into the film was directly dependent on the prior deposition of the polyelectrolyte, and vice-versa. Limited spray times for either component limited the amount of the complementary film component that could be deposited.

Cross-sectional SEM imaging of the composite films showed a striated layer structure that would be expected from platelets stacking vertically in their small dimension (FIG. 3). This observation was also consistent with the film growth rates of between 2.7 and 4.0 nm per bilayer. Surface SEM imaging of the composite film deposited on NF membranes shows uniform coverage of the substrate (FIG. 3).

### Permeability Modeling and Selectivity

Dead-end permeation cell measurements were first made with pure DI water with the intent to determine water permeability, and then with 35,000 ppm NaCl aqueous solution to determine salt permeability at near-seawater conditions.

The model selected reflects the expected diffusive transport mechanism through the selective layer, and simultaneously solves for the water and salt permeability through the film to account for the streaming potential effects. Permeability values were calculated and plotted with respect to film composition (FIG. 6). This intrinsic property enables the clear comparison of permeability values between material systems since it is independent of operating pressure ranges and film thickness.

### REFERENCES

Each of the following references is hereby incorporated by reference in its entirety.

Gleick, P. H., 2006. The World's Water 2006-2007, The Biennial Report on Freshwater Resources. Island Press, Chicago.

Mamedov, A., Kotov, N., Prato, M., Guldi, D., Wicksted, J., Hirsch, A. Molecular design of strong single-wall carbon nanotube/polyelectrolyte multilayer composites. Nature Materials, 2002. 1(3): 190-194.

Srivastava, S., Kotov, N. Composite Layer-by-Layer (LBL) Assembly with Inorganic Nanoparticles and Nanowires. Accounts of Chemical Research, 2008. 41(12): 1831-1841.

Keller, S., Kim, H., Mallouk, T. Layer-by-layer assembly of intercalation compounds and heterostructures on surfaces—toward molecular beaker epitaxy. Journal of the American Chemical Society, 1994. 116(19): 8817-8818.

Cooper, T., Campbell, A., Crane, R. Formation of polypeptide-dye multilayers by an electrostatic self-assembly technique. Langmuir, 1995. 11(7): 2713-2718.

Podsiadlo, P., Choi, S., Shim, B., Lee, J., Cuddihy, M., Kotov, N. Molecularly engineered nanocomposites: Layer-by-layer assembly of cellulose nanocrystals. Biomacromolecules, 2005. 6(6): 2914-2918.

Wood, K., Boedicker, J., Lynn, D., Hammond, P. Tunable Drug Release from Hydrolytically Degradable Layer-by-Layer Thin Films. Langmuir, 2005. 21: 1603-1609.

Lvov, Y., Decher, G., Sukorukov, G. Assembly of thin-films by means of successive deposition of alternate layers of DNA and poly(allylamine). Macromolecules, 1993. 26(20): 5396-5399.

Yoo, P., Nam, K., Qi, J., Lee, S., Park, J., Belcher, A., Hammond, P. Spontaneous assembly of viruses on multilayered polymer surfaces. Nature Materials, 2006. 5(3): 234-240.

Kim, D., Choi, H., Lee, C., Blumstein, A., Kang, Y. Investigation on methanol permeability of Nafion modified by self-assembled clay-nanocomposite multilayers. Electrochimica Acta, 2004. 50(2-3): 659-662.

He, J., Mosurkal, R., Samuelson, L., Li, L., Kumar, J. Dye-sensitized Solar Cell Fabricated by Electrostatic Layer-by-Layer Assembly of Amphoteric TiO₂ Nanoparticles. Langmuir, 2003. 19: 2169-2174.

Krogman, K., Zacharia, N., Schroeder, S., Hammond, P. Automated Process for Improved Uniformity and Versatility of Layer-by-Layer Deposition. Langmuir, 2007. 23: 3137-3141.

Jin, W., Toutianoush, A., Tieke, B. Use of Polyelectrolyte Layer-by-Layer Assemblies as Nanofiltration and Reverse Osmosis Membranes. Langmuir, 2003. 19: 2550-2553.

El-Hashani, A., Toutianoush, A., Tieke, B. Use of layer-by-layer assembled ultrathin membranes of dicopper-[18]azacrown-N₆ complex and polyvinylsulfate for water desalination under nanofiltration conditions. Journal of Membrane Science, 2008. 318: 65-70.

Toutianoush, A., Jin, W., Deligöz, H., Tieke, B. Polyelectrolyte multilayer membranes for desalination of aqueous salt solutions and seawater under reverse osmosis conditions. Applied Surface Science, 2004. 246: 437-443.

Ritchareon, W., Supaphol, P., Pavasant, P. Development of polyelectrolyte multilayer-coated electrospun cellulose acetate fiber mat as composite membranes. European Polymer Journal, 2008. 44: 3963-3968.

Struth, B., Eckle, M., Decher, G., Oeser, R., Simon, P., Schubert, D., Schmitt, J. Hindered ion diffusion in polyelectrolyte/montmorillonite multilayers: Toward compartmentalized films. The European Physical Journal E, 2001. 6: 351-358.

Krogman, K., Lowery, J., Zacharia, N., Rutledge, G., Hammond, P. Spraying asymmetry into functional membranes layer-by-Layer. Nature Materials, 2009. 8: 512-518.

Other embodiments are within the scope of the following claims.

What is claimed is:

1. A reverse osmosis membrane comprising:
a porous substrate;
a multilayer film arranged on the substrate, wherein the multilayer film includes:
a first layer including a polyelectrolyte; and
a second layer including a plurality of clay particles;
wherein the first layer is arranged adjacent to the second layer.

2. The reverse osmosis membrane of claim 1, wherein the multilayer film includes a plurality of bilayers, each bilayer including:
a first layer including a polyelectrolyte; and
a second layer including a plurality of clay particles arranged adjacent to the first layer.

3. The reverse osmosis membrane of claim 1, wherein the multilayer film includes a series of alternating layers, the series alternating between a first layer including a polyelectrolyte and a second layer including a plurality of clay particles arranged adjacent to the second layer.

4. The reverse osmosis membrane of claim 1, wherein the porous substrate is a nanoporous membrane.

5. The reverse osmosis membrane of claim 1, wherein the polyelectrolyte is positively charged when in a neutral aqueous solution.

6. The reverse osmosis membrane of claim 5, wherein the polyelectrolyte includes PDAC.

7. The reverse osmosis membrane of claim 5, wherein the clay particles are negatively charged when in a neutral aqueous solution.

8. The reverse osmosis membrane of claim 7, wherein the clay particles are plate-shaped.

9. The reverse osmosis membrane of claim 7, wherein the clay particles include a laponite clay.

10. The reverse osmosis membrane of claim 2, wherein the multilayer film includes from 5 to 250 bilayers.

11. The reverse osmosis membrane of claim 1, wherein the multilayer film has a total film thickness in the range of 15 nm to 750 nm.

12. A method of making a reverse osmosis membrane, comprising:
building a multilayer film on a substrate, wherein the multilayer film includes:
a first layer including a polyelectrolyte; and
a second layer including a plurality of clay particles;
wherein the first layer is arranged adjacent to the second layer.

13. The method of claim 12, wherein building the multilayer film includes:
(a) depositing the first layer including a polyelectrolyte;
(b) depositing the second layer including a plurality of clay particles over the first layer, thereby forming a bilayer; and
(c) repeating steps (a) and (b) a predetermined number of times.

14. The method of claim 13, wherein depositing the first layer includes spraying a solution of the polyelectrolyte.

15. The method of claim 14, wherein depositing the second layer includes spraying a solution of the clay particles.

16. The method of claim 15, wherein steps (a) and (b) are repeated from 5 to 250 bilayers, thereby forming from 5 to 250 bilayers.

17. A method of desalinating water, comprising:
contacting an aqueous salt solution with one face of a reverse osmosis membrane including:
a porous substrate;
a multilayer film arranged on the substrate, wherein the multilayer film includes:
a first layer including a polyelectrolyte; and
a second layer including a plurality of clay particles;
wherein the first layer is arranged adjacent to the second layer; and
applying pressure to the aqueous salt solution.
